(19) United States
(12) Patent Application Publication
(10) Pub. No.: US 2014/0350705 A1
(43) Pub. Date: Nov. 27, 2014

(54) MUSIC PLAYING SYSTEM AND METHOD

(71) Applicants: HON HAI PRECISION INDUSTRY CO., LTD., New Taipei (TW); Fu Tai Hua Industry (Shenzhen) Co., Ltd., Shenzhen (CN)

(72) Inventors: WEN-DONG LUO, Shenzhen (CN); CHIA-HUNG CHIEN, New Taipei (TW); TSUNG-JEN CHUANG, New Taipei (TW)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 14/096,030

(22) Filed: Dec. 4, 2013

(30) Foreign Application Priority Data
May 24, 2013 (CN) 2013101976011

(51) Int. Cl. G06F 3/16

(52) U.S. Cl. CPC G06F 3/165
USPC 700/94

(57) ABSTRACT

A music playing system is provided. The system includes a control module, an acquiring module, and a playing module. The control module controls the electronic device to enter a predetermined playing mode in response to a first input operation received by the input unit. The acquiring module acquires the name of each song and the start position and end position of the predetermined segment associated with the acquired name of the song from the table when in the predetermined playing mode. The playing module plays the predetermined segment of each song based on the start position and end position of predetermined segment associated with the acquired name of the song. An electronic device and a music playing method are also provided.

### BACKGROUND

1. Technical Field

The present disclosure relates to playing systems, and particularly to a music playing system and a method.

2. Description of Related Art

Music playing devices, such as MP3 players, MP4 players, usually play a whole song based on a startup operation. However, sometimes users have interest in only a small portion of each song, thus requiring users to manually adjust the music playing device to play the interested portion. This is time-consuming.

Therefore, what is needed is a music playing system to overcome the above described limitations.

### BRIEF DESCRIPTION OF THE DRAWING

FIG. 1 is a block diagram of a music playing system in accordance with an exemplary embodiment.

FIG. 2 is a flowchart of a music playing method implemented by the music playing system of FIG. 1.

### DETAILED DESCRIPTION

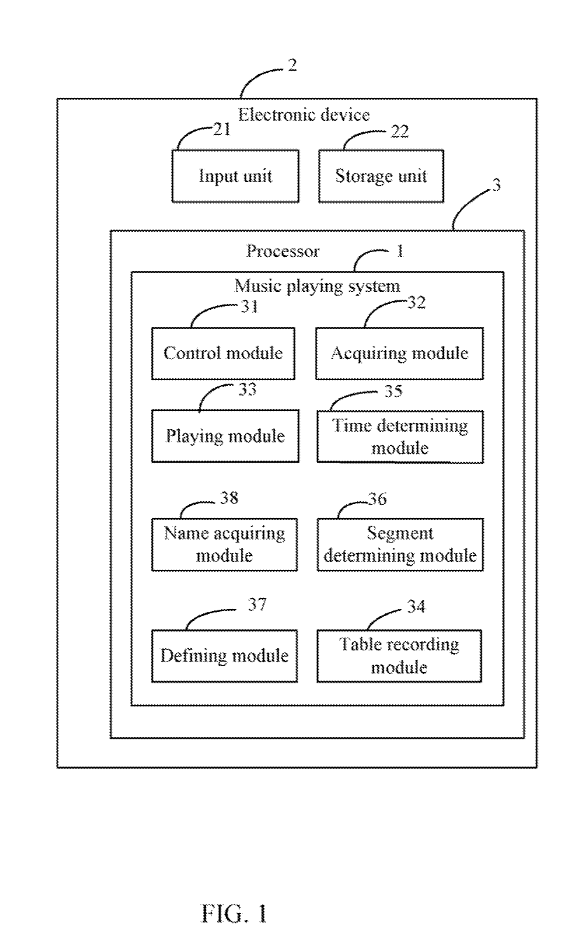

FIG. 1 shows a music playing system 1 (hereinafter “system 1”). The system 1 runs in an electronic device 2. In one embodiment, the electronic device 2 can be a mobile phone, or a music playing device, or the like.

The electronic device 2 includes an input unit 21, a storage unit 22, and a processor 3. The input unit 21 receives input operations. The storage unit 22 stores a number of songs and a table. The table stores a name of each song, a start position and an end position of a predetermined segment within in each song, and relationships between the name of each song and the start position and the end position of the predetermined segment of each song. The start position is a position where the predetermined segment starts, and the end position is the position where the predetermined segment ends.

The processor 3 includes a control module 31, an acquiring module 32, and a playing module 33 which is a collection of software instructions for execution by the processor 3.

The control module 31 controls the electronic device 2 to enter a predetermined playing mode in response to a first input operation received by the input unit 21. The acquiring module 32 orderly acquires the name of each song and the start position and end position of the predetermined segment associated with the acquired name of each song from the table when in the predetermined playing mode. The playing module 33 plays in order the acquired predetermined segment of each song based on the acquired name of each song and the start position and end position of the predetermined segment associated with the acquired name of each song.

The processor 3 further includes a name acquiring module 38, a time determining module 35, a segment determining module 36, a defining module 37, and a table recording module 34 which is collection of software instructions for execution by the processor 3. The control module 31 controls the electronic device 2 to enter a normal playing mode in response to a second input operation received by the input unit 21. The playing module 33 plays the songs in the order stored in the storage unit 22 when in normal playing mode. The time determining module 35 determines if the song is being played for a first time. The name acquiring module 38 acquires the name of the played song when the song is being played for the first time. Each song includes a number of playing points, each of which is assigned an audio frequency and an amplitude. The segment determining module 36 determines a segment, which includes a number of playing points, each of which satisfies a predetermined condition, as the predetermined segment within the played song when the song is played for the first time. In one embodiment, the predetermined condition is that the audio frequency is more than 800 Hz and the amplitude is not less than 0.6Max. In other embodiments, the predetermined condition can be set according to requirement. The defining module 37 defines a starting position of the determined segment as the starting position of the predetermined segment, and an ending position of the determined segment as the ending position of the predetermined segment. The table recording module 34 records the name of the played song, the starting position and ending position of the predetermined segment of the played song, and the relationships between the name of the played song and the starting position and ending position of the predetermined segment of the played song in the table.

In other embodiments, the segment determining module 36 can determine a segment which is repeatedly played as the predetermined segment with in the played song. The defining module 37 can define the starting position and ending position of the determined segment as the starting position and the ending position of the predetermined segment.

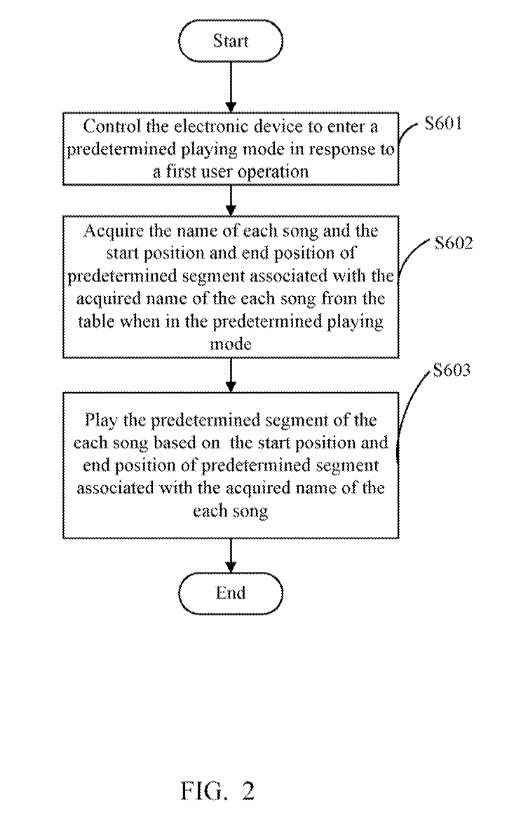

FIG. 2 is a flowchart of a music playing method implemented by the voice self-service system of FIG. 1.

In step S601, the control module 31 controls the electronic device 2 to enter a predetermined playing mode in response to a first user operation.

In step S602, the acquiring module 32 orderly acquires the name of each song and the start position and end position of predetermined segment associated with the acquired name of the each song from the table when in the predetermined playing mode.

In step S603, the playing module 33 plays the predetermined segment of the each song based on the start position and end position of predetermined segment associated with the acquired name of the each song.

The method further includes sub-steps: the control module 31 controls the electronic device 2 to enter a normal playing mode in response to a second input operation received by the input unit 21. The playing module 33 plays the songs stored in the storage unit 22 in order when in the normal playing mode. The time determining module 35 determines if the song is being played for a first time. The name acquiring module 38 acquires the name of the played song when the song is being played for the first time. The segment determining module 36 determines a segment, which includes a number of playing points, each of which satisfies a predetermined condition, as the predetermined segment within the played song when the song is played for the first time. The defining module 37 defines a starting position of the determined segment as the starting position of the predetermined segment, and an ending position of the determined segment as the ending position of the predetermined segment. The table recording module 34 records the name of the played song, the starting position and ending position of the predetermined segment of the played song, and the relationships between the name of the played song and the starting position and ending position of the predetermined segment of the played song in the table.

Although various embodiments have been specifically described, the disclosure is not to be construed as being limited thereto. Various changes or modifications may be made to the embodiments without departing from the scope and spirit of the disclosure.

What is claimed is:

1. A music playing system running in an electronic device, wherein the electronic device comprises an input unit and a storage unit, the input unit is configured to receive input operations, the storage unit is configured to store a plurality songs and a table, the table records a name of each song, a start position and an end position of a predetermined segment within in each song, and relationships between the name of each song and the start position and the end position of the predetermined segment of each song, the music playing system comprising:
at least one processor; and
a plurality of modules to be executed by the at least one processor, wherein the plurality of modules comprises:
a control module configured to control the electronic device to enter a predetermined playing mode in response to a first input operation received by the input unit;
an acquiring module configured to acquire the name of the each song and the start position and the end position of the predetermined segment associated with the acquired name of each song from the table when in the predetermined playing mode; and
a playing module configured to orderly play the predetermined segment of each song based on the start position and end position of predetermined segment associated with the acquired name of each song.

2. The music playing system as described in claim 1, wherein the control module is further configured to control the electronic device to enter a normal playing mode in response to a second input operation received by the input unit, the playing module is further configured to orderly play the song stored in the storage unit when in the normal playing mode, the plurality of modules further comprises:
a time determining module configured to determine whether or not the song is played for a first time;
a name acquiring module configured to acquire the name of the played song when the song is played for the first time, each song comprises a plurality of playing points, each of which is assigned an audio frequency and an amplitude;
a segment determining module configured to determine a segment, which comprises a plurality of playing points, each of which satisfies a predetermined condition, as the predetermined segment within the played song when the song is played for the first time;
a defining module configured to define an starting position of the determined segment as the starting position of the predetermined segment, and an ending position of the determined segment as the ending position of the predetermined segment; and
a table recording module configured to record the acquired name of the played song, the starting position and ending position of the predetermined segment of the played song, and the relationships between the name of the played song and the starting position and ending position of the predetermined segment of the played song in the table.

3. The music playing system as described in claim 2, wherein the predetermined condition is that the audio frequency of the playing point is more than 800 Hz and the amplitude of the playing point is not less than 0.6Max.

4. An electronic device comprising:
an input unit configured to receive input operations;
a storage unit configured to store a plurality songs and a table, wherein the table records a name of each song, a start position and an end position of a predetermined segment within in each song, and relationships between the name of each song and the start position and the end position of the predetermined segment of each song; and
a processor configured to control the electronic device to enter a predetermined playing mode in response to a first input operation received by the input unit, acquire the name of each song and the start position and end position of the predetermined segment associated with the acquired name of the song from the table when in the predetermined playing mode, and orderly play the predetermined segment of each song based on the start position and end position of predetermined segment associated with the acquired name of each song.

5. The electronic device as described in claim 4, wherein the processor is further configured to control the electronic device to enter a normal playing mode in response to a second input operation received by the input unit, orderly play the song stored in the storage unit when in the normal playing mode, determine whether or not the song is played for a first time; acquire the name of the played song when the song is played for the first time, each song comprises a plurality of playing points, each of which is assigned an audio frequency and an amplitude, the processor is further configured to determine a segment, which comprises a plurality of playing points, each of which satisfies a predetermined condition, as the predetermined segment within the played song when the song is played for the first time, define an starting position of the determined segment as the starting position of the predetermined segment, and an ending position of the determined segment as the ending position of the predetermined segment, and record the acquired name of the played song, the starting position and ending position of the predetermined segment of the played song, and the relationships between the name of the played song and the starting position and ending position of the predetermined segment of the played song in the table.

6. The electronic device as described in claim 5, wherein the predetermined condition is that the audio frequency of the playing point is more than 800 Hz and the amplitude of the playing point is not less than 0.6Max.

7. A music playing method running in an electronic device, wherein the electronic device comprises an input unit and a storage unit, the input unit is configured to receive input operations, the storage unit is configured to store a plurality songs and a table, the table records a name of each song, a start position and an end position of a predetermined segment within in each song, and relationships between the name of each song and the start position and the end position of the predetermined segment of each song, the music playing method comprising:
controlling the electronic device to enter a predetermined playing mode in response to a first input operation received by the input unit;
acquiring the name of each song and the start position and end position of the predetermined segment associated with the acquired name of the song from the table when in the predetermined playing mode; and
playing the predetermined segment of each song based on the start position and end position of predetermined segment associated with the acquired name of each song.

8. The music playing method as described in claim 7, further comprising:
controlling the electronic device to enter a normal playing mode in response to a second input operation received by the input unit;
playing the song stored in the storage unit when in the normal playing mode;
determining whether or not the song is played for a first time;
acquiring the name of the played song when the song is played for the first time, wherein each song comprises a plurality of playing points, each of which is assigned an audio frequency and an amplitude;
determining a segment, which comprises a plurality of playing points, each of which satisfies a predetermined condition, as the predetermined segment within the played song when the song is played for the first time;
defining an starting position of the determined segment as the starting position of the predetermined segment, and an ending position of the determined segment as the ending position of the predetermined segment; and
recording the acquired name of the played song, the starting position and ending position of the predetermined segment of the played song, and the relationships between the name of the played song and the starting position and ending position of the predetermined segment of the played song in the table.

9. The music playing method as described in claim 8, wherein the predetermined condition is that the audio frequency of the playing point is more than 800 Hz and the amplitude of the playing point is not less than 0.6Max.
